(19) United States
(12) Patent Application Publication
(10) Pub. No.: US 2013/0305017 A1
(43) Pub. Date: Nov. 14, 2013

(54) COMPILED CONTROL CODE PARALLELIZATION BY HARDWARE TREATMENT OF DATA DEPENDENCY

(71) Applicants: Alexander Rabinovitch, Kfar Yona (IL); Leonid Dubrovin, Karney Shomron (IL); Amichay Amitay, Hod Hasharon (IL)

(72) Inventors: Alexander Rabinovitch, Kfar Yona (IL); Leonid Dubrovin, Karney Shomron (IL); Amichay Amitay, Hod Hasharon (IL)

(21) Appl. No.: 13/466,389

(22) Filed: May 8, 2012

(51) Int. Cl. G06F 9/30

(52) U.S. Cl. 712/205; 712/216; 712/208; 712/E09.016; 712/E09.028

(57) ABSTRACT

An apparatus comprising a buffer and a processor. The buffer may be configured to store a plurality of fetch sets. The processor may be configured to perform a change of flow operation based upon at least one of (i) a comparison between addresses of two memory locations involved in each of two memory accessess, (ii) a first predefined prefix code, and (iii) a second predefined prefix code.

### FIELD OF THE INVENTION

The present invention relates to digital signal processors generally and, more particularly, to a method and/or apparatus for implementing compiled control code parallelization by hardware treatment of data dependency.

### BACKGROUND OF THE INVENTION

Many applications contain parts that are heavy calculations and parts that are control code. The control code determines which calculations to perform. Control code is characterized by a high level of dependency between parts of the code, thus reducing a possibility of parallelizing the code. For example, control code can be characterized by a large number of conditions, conditional code execution, and conditional changes of flow (COF).

Some modern digital signal processors (DSPs) can perform very powerful and fast calculations in parallel, so the control code can become a significant part of the execution cycles. Modern DSP cores are also required to work at high frequencies, so long pipelines with many stages are used. When the control code is compiled there are several restrictions applied to the compiler that can make control code optimization and parallelization even harder and less efficient. One such restriction is a possibility of pointers overlapping, which can be resolved only in runtime. Another such restriction is that each COF requires flushing some part of a pipeline, causing some number of cycles penalty for COF execution. Usually the longer the pipeline of the core, the bigger the COF penalty. In one example, each COF can have a penalty of five cycles. In case of conditional COP, the condition resolution may occur in very late stages of the pipeline. In such a case, the penalty might, for example, be 10 cycles. Many DSP cores have a special mechanism for prediction of a COF target based on history and thus can reduce the COF penalty. However, in many cases a control code history based prediction mechanism almost does not help in prediction of the conditional COF target because the result of condition resolution is nearly random. Thus, large penalties for conditional COFs in control code can result.

It would be desirable to implement a method and/or apparatus for implementing compiled control code parallelization by hardware treatment of data dependency.

### SUMMARY OF THE INVENTION

The present invention concerns an apparatus comprising a buffer and a processor. The buffer may be configured to store a plurality of fetch sets. The processor may be configured to perform a change of flow operation based upon at least one of (i) a comparison between addresses of two memory locations involved in each of two memory accesses, (ii) a first predefined prefix code, and (iii) a second predefined prefix code.

The objects, features and advantages of the present invention include providing a method and/or apparatus for implementing compiled control code parallelization by hardware treatment of data dependency that may (i) implement a special prefix defining that next fetch sets should be fetched from both a target of a conditional change of flow (COF) and sequential code, (ii) implement a special prefix defining that both sequential code and COF target code may be performed in parallel, and the correct results chosen by special logic when the condition is resolved, (iii) implement a special instruction that compares pointers and respective memory access widths, and, if the memory accesses are overlapping, performs a change of flow to sequential code that performs the accesses in correct order, and/or (iv) be implemented in a digital signal processor.

### BRIEF DESCRIPTION OF THE DRAWINGS

These and other objects, features and advantages of the present invention will be apparent from the following detailed description and the appended claims and drawings in which:

FIG. 1 is a block diagram of a pipelined digital signal processor circuit;

FIG. 2 is a block diagram of an example pipeline;

FIG. 3 is a partial block diagram of an example implementation of an example instruction decoder in accordance with a preferred embodiment of the present invention;

FIG. 4 is a diagram illustrating an order for fetching and executing according to a first fetch set prefix; and

FIG. 5 is a diagram illustrating an order for fetching and executing according to a second fetch set prefix.

### DETAILED DESCRIPTION OF THE PREFERRED EMBODIMENTS

Some embodiments of the present invention may implement a special instruction that allows a compiler to change an order defined by a programmer of write and read accesses to memory. The instruction generally uses the fact that a common practice is not to transfer as parameters to a function different pointers that point to the same memory location. The instruction in accordance with embodiments of the present invention generally accepts an address and access width of each of two memory accesses (e.g., read access and write access). The instruction generally compares the addresses of the two memory locations involved in the accesses and performs a change of flow operation to the specified address if the compared memory locations overlap.

In other embodiments of the present invention, a method to reduce a penalty in execution of a conditional change of flow (COF) by a digital signal processor (DSP) core may be implemented. In one example, the penalty may be reduced by instructing the DSP core to perform dual path fetch or dual path fetch and execute. In this way the performance of a large part of DSP code that comprises control code may be greatly improved, thus improving the overall performance of DSP applications.

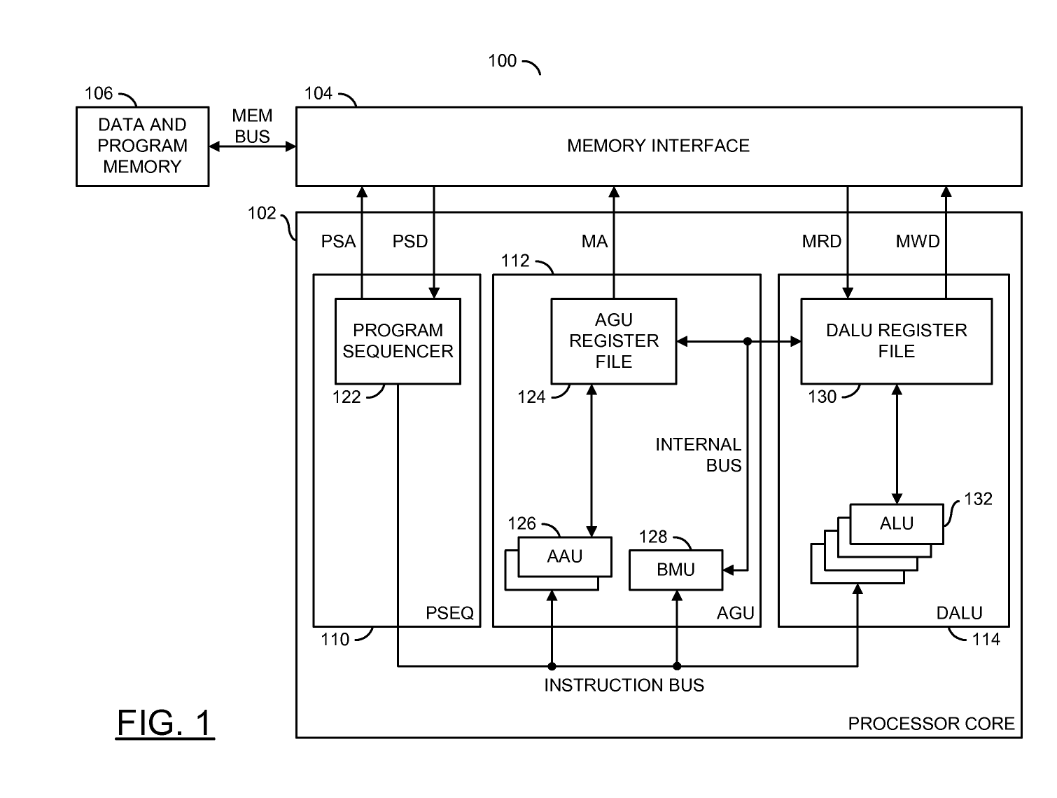

Referring to FIG. 1, a diagram is shown illustrating a circuit 100 in which an embodiment of the present invention may be implemented. The circuit 100 may implement, in one example, a pipelined digital signal processor (DSP) core. The circuit 100 generally comprises a block (or circuit) 102, a block (or circuit) 104 and a block (or circuit) 106. The block 102 generally comprises a block (or circuit) 110, a block (or circuit) 112 and a block (or circuit) 114. The block 110 generally comprises a block (or circuit) 122. The block 112 generally comprises a block (or circuit) 124, one or more blocks (or circuits) 126 and a block (or circuit) 128. The block 114 generally comprises a block (or circuit) 130 and one or more blocks (or circuits) 132. The blocks 102-132 may represent modules and/or circuits that may be implemented as hardware, software, a combination of hardware and software, or other implementations. In some embodiments, the block 104 may be implemented as part of the block 102.

A bus (e.g., MEM BUS) may connect the block 104 and the block 106. A program sequence address signal (e.g., PSA) may be generated by the block 122 and transferred to the block 104. The block 104 may generate and transfer a program sequence data signal (e.g., PSD) to the block 122. A memory address signal (e.g., MA) may be generated by the block 124 and transferred to the block 104. The block 104 may generate a memory read data signal (e.g., MRD) received by the block 130. A memory write data signal (e.g., MWD) may be generated by the block 130 and transferred to the block 104. A bus (e.g., INTERNAL BUS) may connect the blocks 124, 128 and 130. A bus (e.g., INSTRUCTION BUS) may connect the blocks 122, 126, 128 and 132.

The block 106 may implement a memory. The block 106 is generally operational to store both data and instructions used by and generated by the block 102. In some embodiments, the block 106 may be implemented as two or more memory blocks with one or more storing the data and one or more storing the instructions.

The block 104 may implement a memory interface circuit. The block 104 may be operational to transfer memory addresses and data between the block 106 and the block 102. The memory address may include instruction addresses in the signal PSA and data addresses in the signal MA. The data may include instruction data (e.g., fetch sets) in the signal PSD, read data in the signal MRD and write data in the signal MWD.

The block 102 may implement a processor core. The block 102 is generally operational to execute (or process) instructions received from the block 106. Data consumed by and generated by the instructions may also be read (or loaded) from the block 106 and written (or stored) to the block 106. In some embodiments, the block 102 may implement a software pipeline. In some embodiments, the block 102 may implement a hardware pipeline. In other embodiments, the block 102 may implement a combined hardware and software pipeline.

The block 110 may implement a program sequencer (e.g., PSEQ). The block 110 is generally operational to generate a sequence of addresses in the signal PSA for the instructions executed by the block 102. The addresses may be presented to the block 104 and subsequently to the block 106. The instructions may be returned to the block 110 in the fetch sets read from the block 106 through the block 104 in the signal PSD.

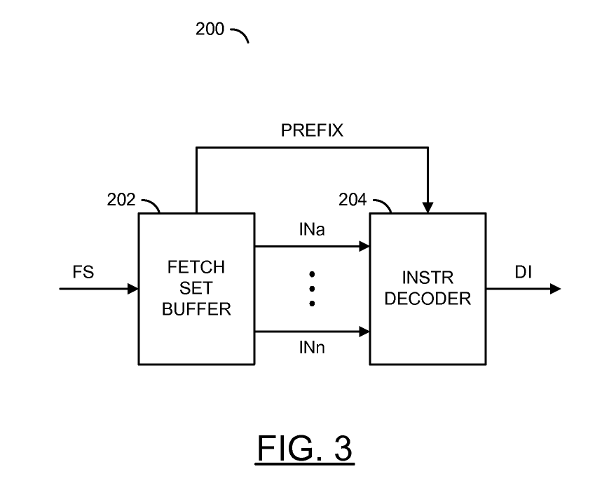

The block 110 is generally configured to store the fetch sets received from the block 106 via the signal PSD in a buffer (described below in connection with FIG. 3). The block 110 may also identify each symbol in each fetch set having the start value. Once the positions of the start values are known, the block 110 may parse the fetch sets into execution sets in response to the symbols having the start value. The instruction words in the execution sets may be decoded within the block 110 (e.g., using an instruction decoder) and presented on the instruction bus to the blocks 126, 128 and 132.

The block 112 may implement an address generation unit (e.g., AGU). The block 112 is generally operational to generate addresses for both load and store operations performed by the block 102. The block 114 may implement a data arithmetic logic unit (e.g., DALU). The block 114 is generally operational to perform core processing of data based on the instructions fetched by the block 110. The block 114 may receive (e.g., load) data from the block 106 through the block 104 via the signal MRD. Data may be written (e.g., stored) through the block 104 to the block 106 via the signal MWD.

The block 122 may implement a program sequencer. The block 122 is generally operational to prefetch a set of one or more addresses by driving the signal PSA. The prefetch generally enables memory read processes by the block 104 at the requested addresses. While an address is being issued to the block 106, the block 112 may update a fetch counter for a next program memory read. Issuing the requested address from the block 104 to the block 106 may occur in parallel to the block 122 updating the fetch counter.

The block 124 may implement an AGU register file. The block 124 may be operational to buffer one or more addresses generated by the blocks 126 and 128. The block 126 may implement one or more address arithmetic units (e.g., AAUs). In one example, the block 126 may be implemented with two AAUs. However, any number of AAUs may be implemented to meet the design criteria of a particular implementation. Each block 126 may be operational to perform address register modifications. Several addressing modes may modify the selected address registers within the block 124 in a read-modify-write fashion. An address register is generally read, the contents modified by an associated modulo arithmetic operation, and the modified address is written back into the address register from the block 126.

The block 128 may implement a bit-mask unit (e.g., BMU). The block 128 is generally operational to perform multiple bit-mask operations. The bit-mask operations generally include, but are not limited to, setting one or more bits, clearing one or more bits and testing one or more bits in a destination according to an immediate mask operand.

The block 130 may implement a DALU register file. The block 130 may be operational to buffer multiple data items received from the blocks 106, 128 and 132. The read data may be receive from the block 106 through the block 104 via the signal MRD. The signal MWD may be used to transfer the write data to the block 106 via the block 104.

The block 132 may implement one or more arithmetic logic units (e.g., ALUs). In one embodiment, the block 132 may implement eight ALUs. However, any number of ALUs may be implemented to meet the design criteria of a particular implementation. Each block 132 may be operational to perform a variety of arithmetic operations on the data stored in the block 130. The arithmetic operations may include, but are not limited to, addition, subtraction, shifting and logical operations.

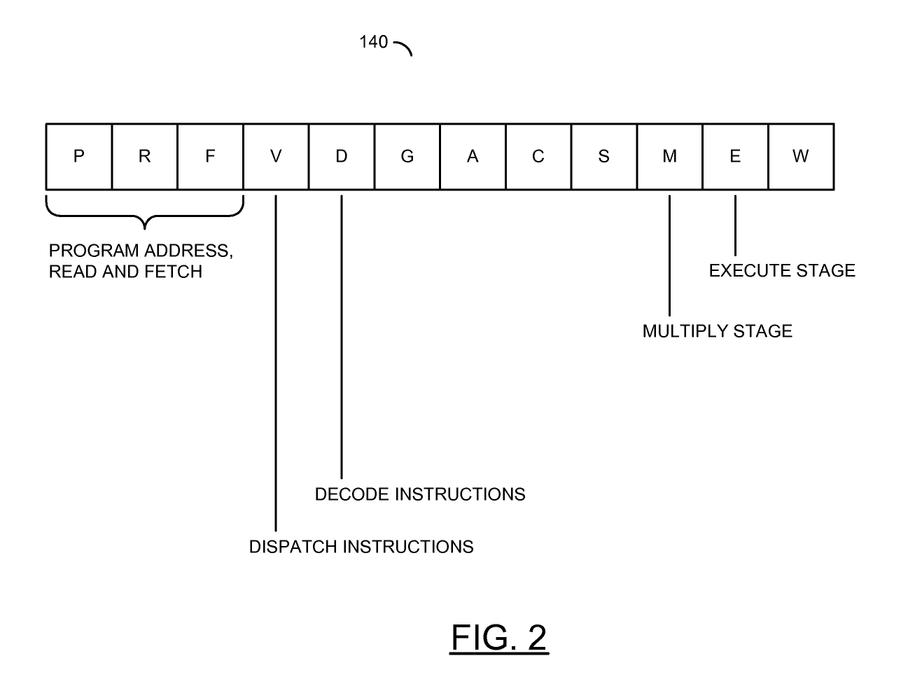

Referring to FIG. 2, a block diagram of a pipeline 140 is shown illustrating an example implementation of a digital signal processor pipeline. The pipeline 140 generally comprises a plurality of stages (e.g., P, R, F, V, D, G, A, C, S, M, E and W). The pipeline may be implemented by the blocks 104 and 102 in FIG. 1. The stage P may implement a program address stage. The stage R may implement a read memory stage. The stage F may implement a fetch stage. The stage V may implement a variable length execution set (VLES) dispatch stage. The stage D may implement a decode stage. The stage G may implement a generate address stage. The stage A may implement an address to memory stage. The stage C may implement an access memory stage. The stage S may implement a sample memory stage. The stage M may implement a multiply stage. The stage E may implement an execute stage. The stage W may implement a write back stage.

During the stage P, fetch sets of addresses may be driven via the signal PSA along with a read strobe (e.g., a prefetch operation) by the block 122. Driving the address onto the signal PSA may enable the memory read process. While the address is being issued from the block 104 to the block 106, the stage P may update the fetch counter for the next program memory read. In the stage R, the block 104 may access the block 106 for program instructions. The access may occur via the bus MEM BUS. During the stage F, the block 104 generally sends the fetch sets to the block 102. The block 102 may write the fetch sets to local registers in the block 110.

During the stage V, the block 110 may parse the execution sets from the fetch sets based on the prefix words. The block 110 may also decode the prefix words in the stage V. During the stage D, the block 110 may decode the instructions in the execution sets. The decoded instructions may be displaced to the different execution units via the instruction bus. During the stage G, the block 110 may precalculate a stack pointer and a program counter. The block 112 may generate a next address for both one or more data address (for load and for store) operations and a program address (e.g., change of flow) operation. During the stage A, the block 124 may send the data address to the block 104 via the signal MA. The block 112 may also process arithmetic instructions, logic instructions and/or bit-masking instructions (or operations).

During the stage C, the block 104 may access the data portion of the block 106 for load (read) operations. The requested data may be transferred from the block 106 to the block 104 during the stage C. During the stage S, the block 104 may send the requested data to the block 130 via the signal MRD. During the stage M, the block 114 may process and distribute the read data now buffered in the block 130. The block 132 may perform an initial portion of a multiply-and-accumulate execution. The block 102 may also move data between the registers during the stage M. During the stage E, the block 132 may complete another portion of any multiply-and-accumulate execution already in progress. The block 114 may complete any bit-field operations still in progress. The block 132 may complete any ALU operations in progress. A combination of the stages M and E may be used to execute the decoded instruction words received via the instruction bus.

During the stage W, the block 114 may return any write data generated in the earlier stages from the block 130 to the block 104 via the signal MWD. Once the block 104 has received the write memory address and the write data from the block 102, the block 104 may execute the write (store) operation. Execution of the write operation may take one or more processor cycles, depending on the design of the block 102.

Referring to FIG. 3, a block diagram of an example implementation of an instruction decoder 200 is shown in accordance with an embodiment of the present invention. The instruction decoder 200 may be implemented as part of a digital signal processor (DSP) core. The instruction decoder 200 generally comprises a block (or circuit) 202 and a block (or circuit) 204. The blocks 202 and 204 may represent modules and/or circuits that may be implemented as hardware, software, a combination of hardware and software, or other implementations.

A signal (e.g., FS) conveying the fetch sets may be received by the block 202. Multiple signals (e.g., INa-INn) carrying the instruction words of a current fetch set may be generated by the block 202 and transferred to the block 204. A signal (e.g., PREFIX) containing a prefix word of the current fetch set may be transferred from the block 202 to the block 204. The block 204 may generate a signal (e.g., DI) containing the decoded instructions.

The block 202 may implement a fetch set buffer block. The block 202 is generally operational to store multiple fetch sets received from the instruction memory via the signal FS. The block 202 may also be operational to present the prefix word and the instruction words in a current fetch set (e.g., a current line being read from the buffer) in the signals PREFIX and INa-INn, respectively.

The block 204 may implement an instruction decoder. The block 204 is generally operational to extract and decode the instruction words belonging to different variable length execution sets (VLESs) based on the symbols in the signal PREFIX. Each extracted group of instruction words may be referred to as an execution set. The extraction may identify each symbol in each of the fetch sets having the start value to identify where a current execution set begins and a previous execution set ends. Once the boundaries between execution sets are known, the block 204 may parse the instructions words in the current fetch set into the execution sets. The parsed execution sets may be decoded. The decoded instructions may be presented in the signal DI to other blocks in the DSP core for data addressing and execution. In some embodiments, the block 204 may be implemented as a single decoder circuit, rather than multiple parallel decoders in common designs. The single decoder implementation generally allows for smaller use of the integrated circuit area and lower power operations.

When control code is compiled there may be several restrictions applied to the compiler that make the control code optimization and parallelization even harder and less efficient. One of the restrictions involves a possibility of pointers overlapping, which can be resolved only in runtime. An example of such a problem may be illustrated using the following C function:

```
Void func (short *a,short *b , int *c, int *d)
{
    if ( a[3] < a[7])
        *b = 1;
    if (*c > *d)
        *d =*c;
}
```

In the above example, the data for the second condition (*c and *d) is not allowed to be read from memory before the first condition is fully evaluated and *b is stored to the memory. The restriction is necessary because the conventional compiler does not know in the compilation time if one of pointers c or d is equal to or overlapped with the pointer b. The conventional compiler assumes the worst case scenario that all pointers point to the same memory location, so the conventional compiler waits until the data is stored and only then reads the *c and *d. The above restriction strongly affects the control code performance. In an assembly language example, the example above may be implemented as follows:

| | | |
|---|---|---|
| move.w (r0+3*4),d0 | move.w (r0+7*4),d1 | clr d3 ;fetch a[3] and a[7] |
| cmpgt d0, d1 | inc d3 | ;if (a[3] < a[7]) |
| ift move.w d3, (r1) | ;store b | |
| move.1 (r2),d4 | move.1 (r3),d5 | ;fetch *c and *d |
| cmpgt d5,d4 | | ;if (*c > *d) |
| ift move.1 d4, (r3) | | ;store *d |

The same restriction applies to both cases of read after write and write after read.

In embodiments of the present invention, a new instruction may be implemented that compares the pointers and the memory access width. The new instruction may be referred to, in one example, as READ_WRITE_COF. If the memory accesses are overlapping, the new instruction performs a change of flow operation on the sequential code to perform the accesses in correct order. The new instruction generally allows the compiler to change the order defined by a programmer of write and read accesses to memory. The new instruction generally uses the fact that a common practice is not to transfer different pointers that point to the same memory location as parameters to a function. The new instruction generally accepts an address and access width of each of two memory accesses (e.g., a read access and a write access). The new instruction generally compares the addresses of the two memory locations involved in the accesses and performs a change of flow operation to the specified address if the compared memory locations overlap.

For example, if a read access of four bytes is performed to address 0x100 then the memory locations accessed are 0x100, 0x101, 0x102, 0x103. If a write access of 2 bytes is performed to address 0x108 then the memory locations accessed are 0x108, 0x109, and there is no overlap. If a write access of 2 bytes is performed to address 0x102 then the memory locations accessed are 0x102, 0x103 and there is overlapping. Because there is overlapping, a change of flow is performed. Using the new instruction READ_WRITE_COF in accordance with an embodiment of the present invention, the example provided above may be rewritten as follows:

| | |
|---|---|
| move.w (r0+3*4),d0 | move.w (r0+7*4),d1 clr d3 |
| cmpgt d0,d1 | inc d3 move.1 (r2),d4 move.1 (r3),d5 |

ift move.w d3, (r1) ifa cmpgt d5,d4 READ_WRITE_COF
r2,4,r1,2,_seq_code

| | |
|---|---|
| ift move.1 d4, (r3) | ifa READ_WRITE_COF r3,4,r1,2,_seq_code |

_return_from_seq_code

In the example above, the instruction READ_WRITE_COF r2,4,r1,2,_seq_code checks whether a 4 bytes wide memory access to the address in r2 and 2 bytes wide memory access to the address in r1 access the same memory location. If so, a branch to sequential code is performed:

| | |
|---|---|
| _seq_code | |
| move.1 (r2),d4 move.1 (r3),d5 | ;fetch *c and *d |
| cmpgt d5,d4 | ;if (*c > *d) |
| ift move.1 d4,(r3) | ;store *d |
| jmp_return_from_seq_code | ;return from the sequential code |

In the sequential code the data is accessed in correct order and the result is correct. The sequential code is almost never accessed and the code performance may be greatly improved. In the example above the code with the new instruction is performed in four cycles and without the new instruction in 6 cycles; a 50% degradation without the new instruction.

In another embodiment of the present invention, dual path fetch and execution prefixes may be used to implement a conditional change of flow (COF). Prefix codes may be implemented that reduce the penalty for execution of conditional change of flow in a DSP core by instructing the DSP core to perform dual path fetch or dual path fetch and execute. In this way the performance of a large part of DSP code that comprises control code may be greatly improved, thus improving the overall performance of DSP applications.

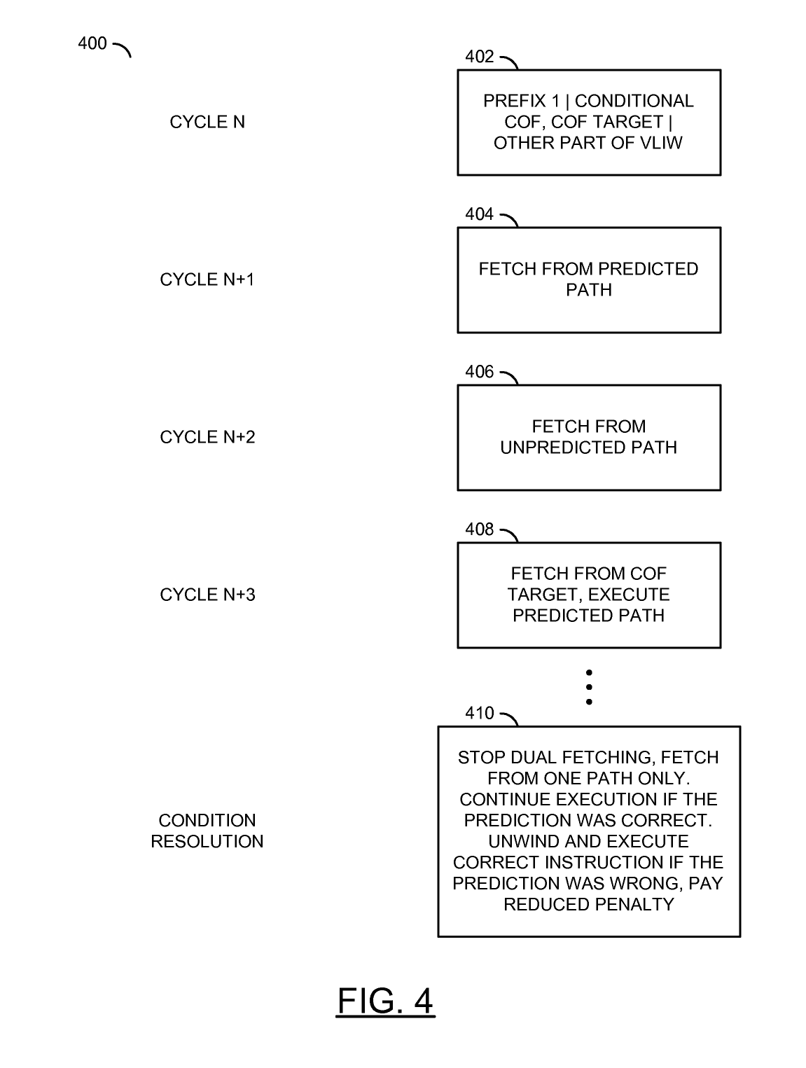

Referring to FIG. 4, a flow diagram of a process 400 is shown illustrating an operation after detection of a first special prefix in accordance with an embodiment of the present invention. A special prefix (e.g., PREFIX 1) may be implemented defining that the next fetch sets should be fetched from both the target of conditional COF and sequential code. The prefix may either include the target address or the address may be taken from the COF instruction or a branch targets buffer (BTB).

In one example, a DSP core may be configured to perform a number of steps (or states) 402-410 in response to the prefix PREFIX 1. In a first cycle (e.g., Cycle N), the process (or method) 400 moves to the step 402 and obtains the prefix PREFIX 1 along with the target address or the address taken from the COF instruction or a branch targets buffer (BTB). The DSP core may begin dual fetching in response to receiving the prefix PREFIX 1. In a next cycle (e.g., Cycle N+1) the process 400 moves to the step 404 to fetch from a predicted path. In a next cycle (e.g., Cycle N+2) the process 400 moves to the step 406 to fetch from an unpredicted path. In a next cycle (e.g., Cycle N+3) the process 400 moves to the step 408 to fetch from the COF target and execute the predicted path code. The process 400 may continue dual fetching until the condition of the conditional COF is resolved. When the condition is resolved, the process 400 moves to the step 410. In the step 410, the process 400 stops dual fetching and begins fetching from only one path. The process 400 checks to see whether the prediction was correct. If the prediction was correct, execution continues. If the prediction was not correct, the process 400 unwinds and executes the correct instruction.

The prefix PREFIX 1 may be implemented in a very long instruction word (VLIW) architecture to instruct the core to fetch program data from both the COF target and the sequential code. In control code there is a high level of dependency between operations (e.g., operations depend on the result of previous operations), thus even though several units may be implemented in a DSP core, almost no parallelization is possible and the utilization of the units may be very small. This means that each fetch set may contain several VLIWs and it is enough to fetch one fetch set per several cycles to prevent a core from suffering program data starvation. The prefix PREFIX 1 informs the core that the VLIWs following the conditional COF are short and the core may fetch the program data one cycle from the COF target and one cycle sequential code, starting from the target code (sequential code is most probably partially in the fetch buffer). When the conditional COF is executed speculatively then either sequential code or COF target code is executed based on some prediction. If after condition resolution the prediction is found to be wrong, the correct code is already in the fetch buffer, thus reducing the penalty of fetching the sequential code from the memory. In the instance when the prefix PREFIX 1 is used, only the penalty cycles of fetching from memory are reduced. In one example, the penalty reduction may be 3 cycles.

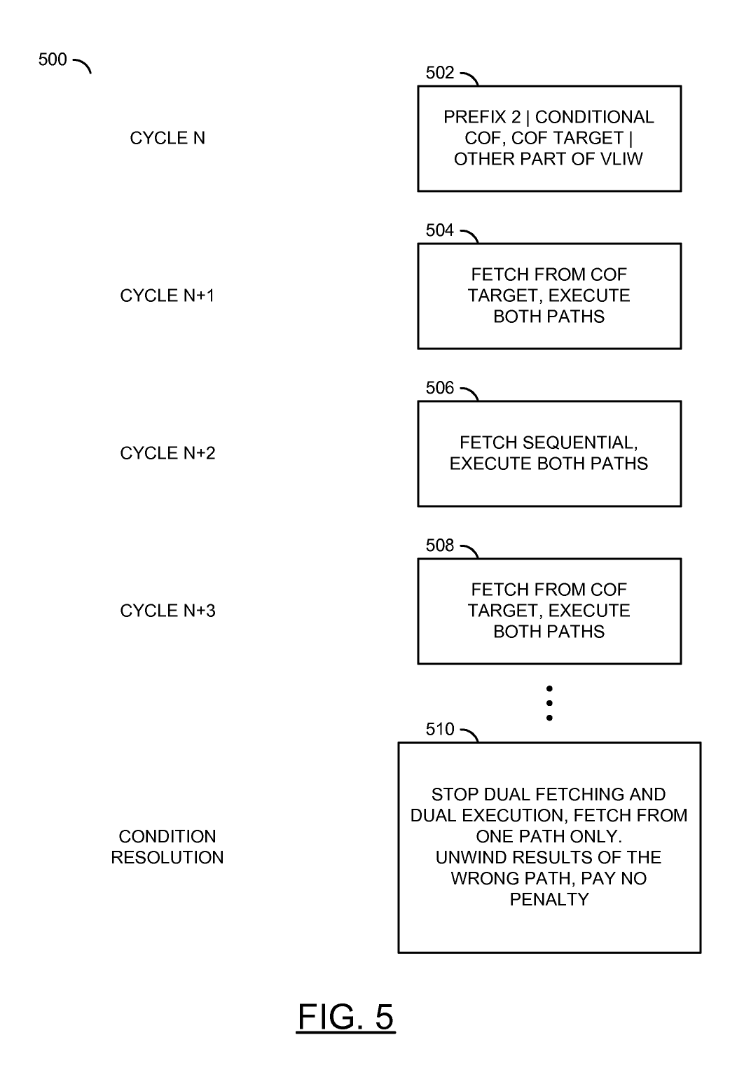

Referring to FIG. 5, a flow diagram of a process 500 is shown illustrating an operation after detection of a second special prefix in accordance with an embodiment of the present invention. Another special prefix (e.g., PREFIX 2) may be implemented defining that both sequential code and COF target code may be performed in parallel, and the correct results chosen by special logic when the condition is resolved.

In one example, a DSP core may be configured to perform a number of steps (or states) 502-510 in response to the prefix PREFIX 2. In a first cycle (e.g., Cycle N), the process (or method) 500 moves to the step 502 and obtains the prefix PREFIX 2 along with the target address or the address taken from the COF instruction or a branch targets buffer (BTB). The DSP core may begin dual fetching and execution in response to receiving the prefix PREFIX 2. In a next cycle (e.g., Cycle N+1) the process 500 moves to the step 504 to fetch from the COF target and execute both the predicted and the unpredicted path code. In a next cycle (e.g., Cycle N+2) the process 500 moves to the step 506 to fetch from the sequential path and execute both the predicted and the unpredicted path codes. In a next cycle (e.g., Cycle N+3) the process 500 moves to the step 508 to fetch from the COF target and execute both the predicted and unpredicted path code. The process 500 may continue dual fetching and executing until the condition of the conditional COF is resolved. When the condition is resolved, the process 500 moves to the step 510. In the step 510, the process 500 stops dual fetching and dual execution, and begins fetching from only one path. The process 500 checks to see which path was correct and unwinds the results of the incorrect path.

The prefix PREFIX 2 generally instructs the core to execute both TRUE and FALSE paths of the conditional code in parallel. The prefix PREFIX 2 may be used only when there are enough core resources for parallel execution of both paths. The prefix PREFIX 2 is generally a superset of prefix PREFIX 1, meaning that the prefix PREFIX 2 instructs the core to fetch from both paths and execute the paths in parallel. When the condition of the conditional COF is resolved, special logic kills the wrong results and prevents the wrong results from affecting the core registers and memory. In the instance when PREFIX 2 is used, all the COF penalty cycles are generally reduced. In one example, the penalty reduction may be 10 cycles.

The functions performed by the diagrams of FIGS. 1-5 may be implemented using one or more of a conventional general purpose processor, digital computer, microprocessor, microcontroller, RISC (reduced instruction set computer) processor, CISC (complex instruction set computer) processor, SIMD (single instruction multiple data) processor, digital signal processor (DSP), central processing unit (CPU), arithmetic logic unit (ALU), video digital signal processor (VDSP) and/or similar computational machines, programmed according to the teachings of the present specification, as will be apparent to those skilled in the relevant art(s). Appropriate software, firmware, coding, routines, instructions, opcodes, microcode, and/or program modules may readily be prepared by skilled programmers based on the teachings of the present disclosure, as will also be apparent to those skilled in the relevant art(s). The software is generally executed from a medium or several media by one or more of the processors of the machine implementation.

The present invention may also be implemented by the preparation of ASICs (application specific integrated circuits), Platform ASICs, FPGAs (field programmable gate arrays), PLDs (programmable logic devices), CPLDs (complex programmable logic device), sea-of-gates, RFICs (radio frequency integrated circuits), ASSPs (application specific standard products), one or more monolithic integrated circuits, one or more chips or die arranged as flip-chip modules and/or multi-chip modules or by interconnecting an appropriate network of conventional component circuits, as is described herein, modifications of which will be readily apparent to those skilled in the art(s).

The present invention thus may also include a computer product which may be a storage medium or media and/or a transmission medium or media including instructions which may be used to program a machine to perform one or more processes or methods in accordance with the present invention. Execution of instructions contained in the computer product by the machine, along with operations of surrounding circuitry, may transform input data into one or more files on the storage medium and/or one or more output signals representative of a physical object or substance, such as an audio and/or visual depiction. The storage medium may include, but is not limited to, any type of disk including floppy disk, hard drive, magnetic disk, optical disk, CD-ROM, DVD and magneto-optical disks and circuits such as ROMs (read-only memories), RAMs (random access memories), EPROMs (erasable programmable ROMs), EEPROMs (electrically erasable programmable ROMs), UVPROM (ultra-violet erasable programmable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, audio storage and/or audio playback devices, video recording, video storage and/or video playback devices, game platforms, peripherals and/or multi-chip modules. Those skilled in the relevant art(s) would understand that the elements of the invention may be implemented in other types of devices to meet the criteria of a particular application.

The terms “may” and “generally” when used herein in conjunction with “is(are)” and verbs are meant to communicate the intention that the description is exemplary and believed to be broad enough to encompass both the specific examples presented in the disclosure as well as alternative examples that could be derived based on the disclosure. The terms “may” and “generally” as used herein should not be construed to necessarily imply the desirability or possibility of omitting a corresponding element.

While the invention has been particularly shown and described with reference to the preferred embodiments thereof, it will be understood by those skilled in the art that various changes in form and details may be made without departing from the scope of the invention.

1. An apparatus comprising:
a buffer configured to store a plurality of fetch sets; and
a processor configured to perform a change of flow operation based upon at least one of (i) a comparison between addresses of two memory locations involved in each of two memory accesses, (ii) a first predefined prefix code, and (iii) a second predefined prefix code.

2. The apparatus according to claim 1, wherein at least one of said fetch sets comprises a prefix word and said processor is configured to select either a dual path fetch operation or a dual path fetch and execute operation in response to said prefix word containing said first predefined prefix code or said second predefined prefix code, respectively.

3. The apparatus according to claim 1, wherein each of said fetch sets comprises a variable length execution set.

4. The apparatus according to claim 1, wherein said processor comprises a very long instruction word (VLIW) architecture.

5. The apparatus according to claim 1, further comprising a single decoder configured to generate one or more decoded instructions by decoding execution sets.

6. The apparatus according to claim 5, wherein said decoded instructions are dispatched from said decoder to a plurality of execution units.

7. The apparatus according to claim 1, wherein each of said predefined prefix codes reduce a penalty in execution of a conditional change of flow (COF) by a digital signal processor (DSP) core.

8. The apparatus according to claim 7, wherein said first predetermined prefix code reduces a penalty of fetching from memory.

9. The apparatus according to claim 7, wherein said second predetermined prefix code reduces all change of flow penalty cycles.

10. The apparatus according to claim 1, wherein said apparatus is implemented as one or more integrated circuits.

11. A method of control code parallelization through hardware treatment of data dependency, comprising the steps of:
buffering a plurality of fetch sets; and
performing a change of flow operation in a processor based upon at least one of (i) a comparison between addresses of two memory locations involved in each of two memory accessess, (ii) a first predefined prefix code, and (iii) a second predefined prefix code.

12. The method according to claim 11, wherein at least one of said fetch sets comprises a prefix word, said method further comprising:
selecting a dual path fetch operation of said processor in response to said prefix word containing said first predefined prefix code; and
selecting a dual path fetch and execute operation of said processor in response to said prefix word containing said second predefined prefix code.

13. The method according to claim 11, wherein each of said fetch sets comprises a variable length execution set.

14. The method according to claim 11, wherein said processor comprises a very long instruction word (VLIW) architecture.

15. The method according to claim 11, further comprising:
generating one or more decoded instructions by decoding execution sets using a single decoder configured.

16. The method according to claim 15, wherein said decoded instructions are dispatched from said decoder to a plurality of execution units of said processor.

17. The method according to claim 11, wherein said processor comprises a digital signal processor (DSP) core and each of said predefined prefix codes reduce a penalty in execution of a conditional change of flow (COF) instruction.

18. The method according to claim 17, wherein said first predetermined prefix code reduces a penalty of fetching from memory.

19. The method according to claim 17, wherein said second predetermined prefix code reduces all change of flow penalty cycles.

20. An apparatus comprising:
means for storing a plurality of fetch sets; and
means for performing a change of flow operation based upon at least one of (i) a comparison between addresses of two memory locations involved in each of two memory accesses, (ii) a first predefined prefix code, and (iii) a second predefined prefix code.
